(19) United States
(12) Patent Application Publication
(10) Pub. No.: US 2006/0079109 A1
(43) Pub. Date: Apr. 13, 2006

(54) Quick-disconnect threaded connector

(76) Inventors: Neal Castleman, Malibu, CA (US); Eddy Castillo, Hawthorne, CA (US); Stephen K. Yamamoto, Los Angeles, CA (US)

Correspondence Address: PETER I. LIPPMAN, 17900 MOCKINGBIRD LANE, RENO, NV, 89506, US

(21) Appl. No.: 11/243,451

(22) Filed: Oct. 3, 2005

Related U.S. Application Data
(60) Provisional application No. 60/615,670, filed on Oct. 4, 2004.

(51) Int. Cl. H01R 13/62

(52) U.S. Cl. 439/312

(57) ABSTRACT

The invention enables a true quick-release connection to a completely standard threaded electrical plug (or receptacle). The mating connector engages the standard threads with a group of radial pins, rather than with conventional, circumferential mating threads. Preferably each pin is generally cylindrical, but has one part (ordinarily a tip) shaped for best engagement with the threads; and another part shaped for engagement with a pin-retracting cam. Most commonly the threads and the thread-engaging part of each pin are complementarily tapered. The connectors are screwed together in a conventional way; but for quick release the cam radially retracts all the pins from the threads simultaneously.

### RELATION BACK

This document claims priority of U.S. provisional patent application Ser. No. 60/615,670, filed Oct. 4, 2004.

### FIELD OF THE INVENTION

This invention relates to apparatus and procedures for instant disconnection of an electrical connector pair that has been threaded together.

### BACKGROUND

Very broadly, two general kinds of connectors are known for connecting and disconnecting modules such as mating electrical circuits: threaded- or screw-type connectors, and bayonet-type connectors. Threaded connectors have the advantage of strength and stability, but unfortunately are time consuming to disconnect.

Bayonet or snap-together connectors are sometimes regarded as prone to accidental disconnection. Thus they pose a risk of possible damage to equipment—and in some cases more-serious adverse consequences.

Another reason for avoiding bayonet connector designs, however, is much more difficult to disregard: some devices must mate with apparatus that by law (or government-promulgated regulations) must have certain completely specified connection geometry. That geometry may include screw-together attachment components.

In particular one very commonly required standard military unit is known as a “D-38999 series III” connector. It has a triple-start Acme thread, and is designed to tolerate high vibration and shock; however, being a screw-together connector it is objectionably slow to disconnect.

Quick-disconnect variants of this connector are particularly favored for hostile subsystems, such as for example bombs and missiles, that are connected to aircraft and must automatically separate from the craft in flight. Under the conditions of such deployment, rapid but extremely reliable disengagement is necessary.

Neither time nor manual access is usually available for tending to the connectors manually if automatic release fails. As will be understood, midair failure to disengage can produce severe damage to the aircraft and potentially major hazards to its crew.

Three prior-art devices attempt to accommodate the general geometry of the D-38999 connector. A first of these requires a modified (i. e., not standard) version of the D-38999 plug, as well as the mating receptacle.

In this variant plug, three or more balls are captured between two metal pieces linked to the shell, and the mating receptacle is grooved rather than threaded. In a quiescent condition the balls lock the plug and receptacle together longitudinally—functioning in lieu of standard threads in the receptacle.

One of the metal pieces forms a cammed shape, so that when pulled back (by retracting the shell) it releases the balls. The balls thereby become loose and move in the groove of the receptacle. When the shell is released it forces the balls into the groove.

A second device that attempts to accommodate the general geometry of the D-38999 geometry also requires a variant of the plug as well as the receptacle. In this case the receptacle has a bayonet pin that projects from the receptacle.

To connect the plug and receptacle together, a slotted screw mechanism is screwed over the bayonet pin, locking the receptacle and plug together. Here it is this pin which functions in place of threads in the receptacle. For quick release, the slotted mechanism opens to release the bayonet pin.

A major drawback of both these first two devices is that they in fact require the modification. That is, neither can work with the standard D-38999 series III plug; hence the standard military specification is not applicable to either the receptacle or the plug.

A third prior device carries an internally threaded ring on the inside of the receptacle, generally like the standard receptacle, but the threaded ring is not continuous all the way around the receptacle. The ring instead takes the form of segments, or sections, usually six segments around the receptacle circumference.

To connect the two half-connectors together the plug is screwed into the threads, in the usual way. For quick disengagement the thread segments are retractable radially, so that in principle it is not necessary to unscrew the components from each other—they can simply come apart longitudinally.

Thus the receptacle of this third device, unlike the first two, undertakes to mate with a completely standard D-38999 series III plug. Only the receptacle is nonstandard. Unfortunately the release is unreliable: the segmented threads of the receptacle sometimes catch on the plug threads instead of retracting cleanly.

Since the standard threads are triple-start, the longitudinal spacing of adjacent threads is quite fine. Hence the interfitting of the plug and receptacle threads entails a relatively large total contact surface area at each segment.

Disengagement of such finely spaced large contact areas develops significant friction—so that the segmented threads tend to catch, in retraction, rather than separating smoothly. While it is not intended to unduly criticize the efforts of prior artisans in the field, this is a highly unacceptable mode of failure since it can rip the associated cabling and attached hardware bodily out of the host system.

As can be now understood, the prior art—although providing many thousands of different connector configurations—has left some refinements to be desired in the area of threaded electrical connectors that are very quickly disconnected.

### SUMMARY OF THE INVENTION

The present invention provides just such refinements. In preferred aspects and preferred embodiments of the invention, mechanisms are provided that thread together with standard screw-together connector plugs in a way that appears conventional, and in fact can be unscrewed in a likewise conventional-seeming way—but that also can be instantaneously disconnected, either with one hand or by automatic machine operation of a rip cord or the like.

This result provides a significant improvement in terms of the compatibility of quick-disconnection devices with completely standard specifications of mating apparatus. All this is set forth in the Detailed Description section of this document, with reference to the accompanying drawings—of which:

### BRIEF DESCRIPTION OF THE DRAWINGS

FIG. 1 is a side elevation, in longitudinal section, of a preferred embodiment of the invention showing full engagement with a substantially conventional, standard mating connector;

FIG. 2 is a cross-sectional elevation taken along the line 2-2 of FIG. 1;

FIG. 3 is a diagram like FIG. 1, but with the apparatus in condition for disengagement from the mating connector;

FIG. 4 is a diagram like FIG. 2, but for disengagement as in FIG. 3, and taken along the line 4-4 of FIG. 3;

FIG. 5 is a longitudinal-section elevation including disconnection-mechanism details of the FIG. 1 assemblage (near the top-right corner of FIG. 1) but now very greatly enlarged;

FIG. 6 is an even more greatly enlarged view, now in isometric or perspective format, of the FIG. 5 disconnection-mechanism details;

FIG. 7 is a top plan view very generally like FIG. 1, i. e. with the two half-connectors fully engaged, but taken from an orthogonal viewpoint (a top plan)—to more clearly show the disconnection-control lanyard and its attachment points;

FIG. 8 is a left end elevation corresponding to the engaged condition of FIGS. 1, 2 and 7, and particularly showing the lanyard;

FIG. 9 is a view like FIG. 7 but with the mechanism instead in condition for disengagement, again showing the lanyard; and

FIG. 10 is a view like FIG. 8 but corresponding to the disengagement condition of FIGS. 3, 4 and 8.

### DETAILED DESCRIPTION OF PREFERRED EMBODIMENTS

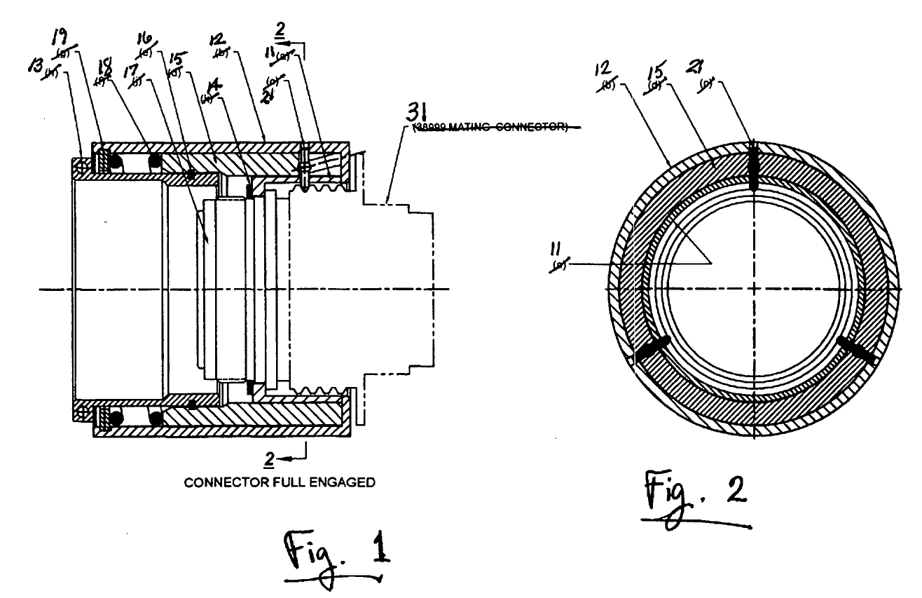

In a preferred embodiment, the invention 11-19, 21-29′ (FIGS. 1, 2, 5 and 6) may hold or include a conventional, generally standard connector receptacle 17, which is engaged with a mating generally standard threaded connector plug 31 such as the previously mentioned D-38999 military item. In this condition, an externally controllable lanyard sleeve 13 is at rest, springloaded axially away from the mating plug 31.

The preferred embodiment of the invention does not use continuous threads as such, but rather engages the mating threads of the other half-connector 31 by a multiplicity of circumferentially distributed thread-engagement pins 21. Three such pins are illustrated (FIG. 2) and currently considered ideal for most applications; however, a greater number such as six, twelve or even more pins 21 can be provided for much greater strength and stability or for other reasons as may be preferred.

As noted earlier, the plug 31 may be a multiple-start type—for instance a military-specification “D-38999 series III” half-connector, with a triple-start Acme thread. In such a case it is essential that the pins be positioned in the receptacle precisely, to properly engage the finely spaced plug threads.

In most cases the pins are ideally spaced equidistant about the periphery of the assembly 11-19, 21-29′, especially about a coupling sleeve 11 and outer sleeve 12. Holes 22 in both these sleeves hold each pin in a radial alignment.

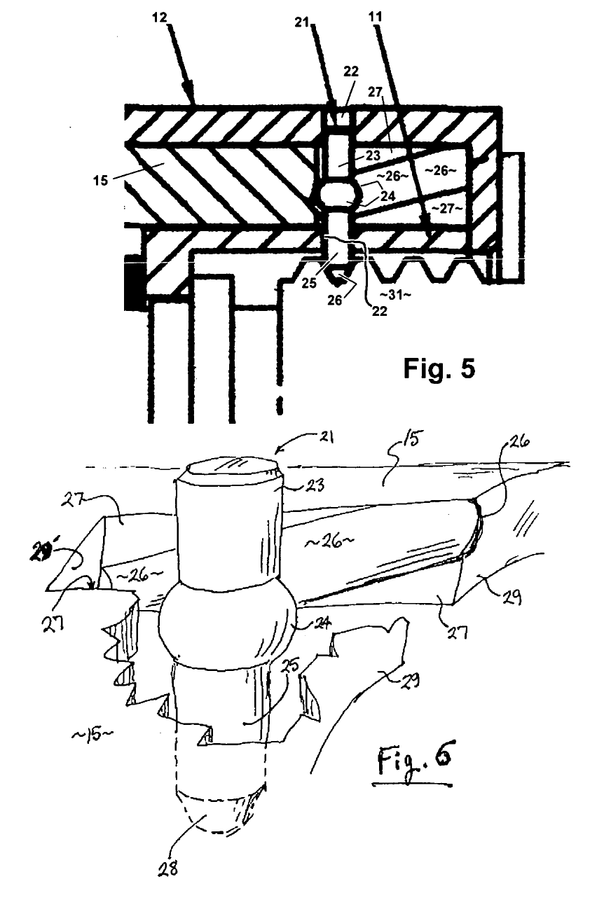

Each pin also stands in a respective axial slot 27, 29′ (best shown in FIGS. 5 and 6) formed near the front—rightward, as drawn—edge 29 of a pin-actuator sleeve 15. The actuator sleeve is radially between the coupling and outer sleeves 11, 12; and is keyed by a retaining ring 16 to the previously mentioned lanyard sleeve 13 so that the actuator sleeve can be jerked back—leftward—by the lanyard sleeve.

A very generally central bulb or enlargement 24 is formed in each pin 21, between the radially outer and inner pin segments 23, 25. At the radially innermost end of each pin 21, the tip 28 is ideally shaped to match the cross-sectional thread profile of the mating connector 31—e. g. often but not necessarily tapered.

The central bulb 24 rests in angled grooves 26 formed in opposing faces of the corresponding actuator slot 27. Axial motion of the actuator sleeve cams the pin radially in or out through its alignment holes 22.

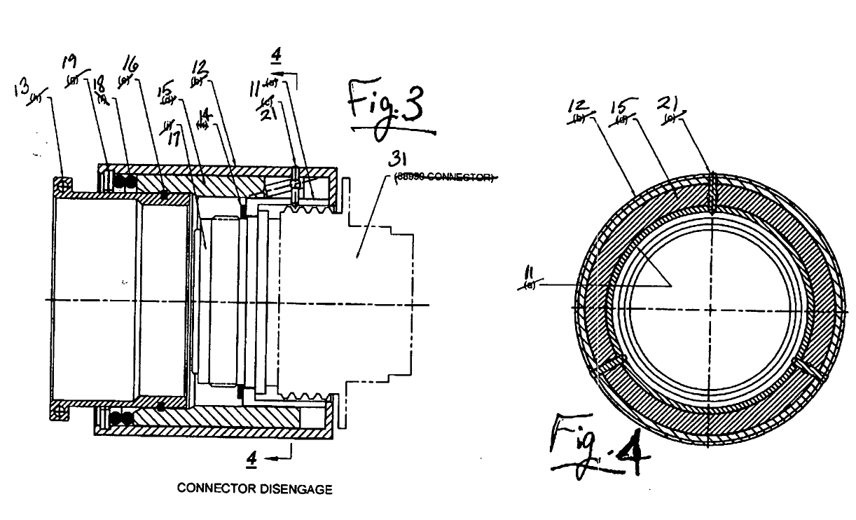

For connection, ideally the mating unit 31 is screwed in, or if preferred the lanyard sleeve 13 can be pulled out (FIGS. 3 and 4) to operate the pin-actuator sleeve and thereby extract the pins from the path of the threads—permitting insertion of the mating plug 31. In the case of the latter method, once the two are fully seated the lanyard and actuator sleeves are released and driven rearward by a coil spring 18 to reposition the pins in the threads.

The coil spring seats against a retaining ring 19 that references the spring to the outer sleeve or shell 12 and thus to the pins 21. This method of engaging the half-connectors is somewhat undesirable in that the threads may not happen to be aligned precisely with the pins; to minimize the likelihood of problems due to use of this method, the threaded connector ring at least should be slightly rotated about the system axis to obtain a good engagement. With square-profile threads this technique may not be advisable.

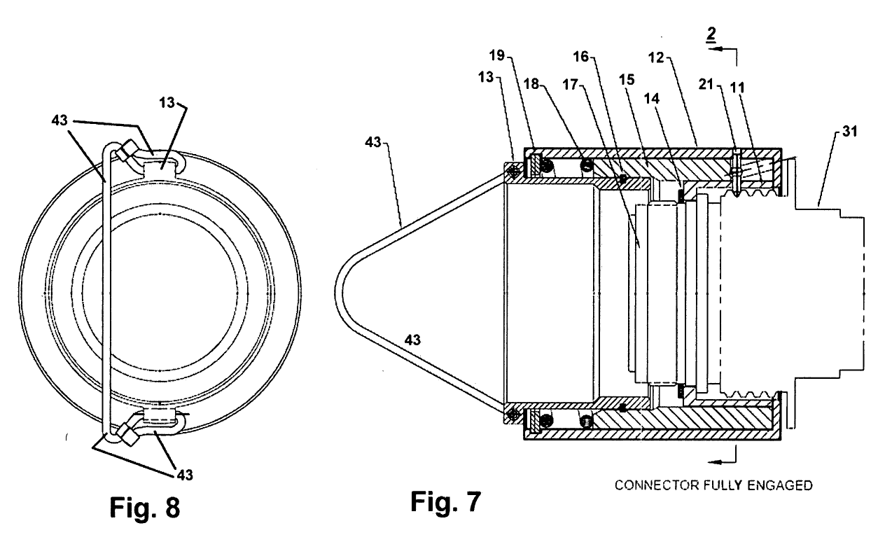

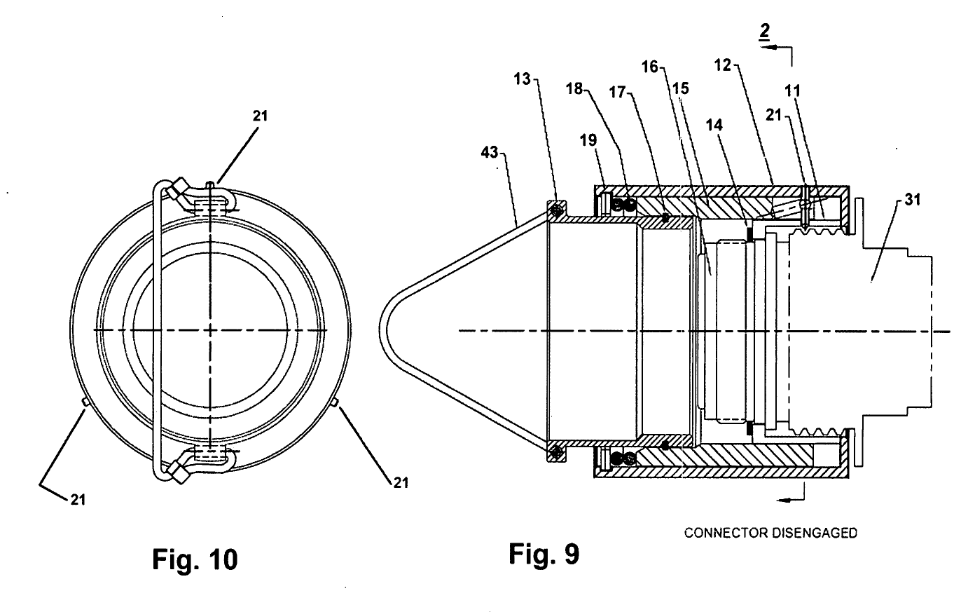

To disengage the connectors, the lanyard 43 (FIGS. 7 through 10) is pulled rearward, either manually or by machine action—as for instance by separation of a module associated with the mating plug 31 from a module associated with the previously mentioned connector 17 held in or part of the present invention. This action of lanyard 13′ in turn, commonly effectuated in rip-cord mode of operation, pulls out the lanyard sleeve and with it the pin-actuator sleeve.

As the actuator sleeve retreats, each pin 21 rides up its ramped groove 26 in the corresponding slot 27. This cam action extracts all the pins simultaneously from the mating threads and thereby instantly releases the two half-connectors 17, 31 from each other—even if the threaded half 31 was initially screwed into place.

It has been found that this arrangement of pins provides an excellent solution to the previously mentioned prior-art problem of obtaining smooth, reliable and very fast disengagement. Yet this solution is achieved with a D-38999 series III plug 31 that is completely standard.

The foregoing details are intended to be merely exemplary, not exhaustive, and therefore should not be misinterpreted as limiting the invention or its applications to what has been specifically set forth. A person skilled in the field will understand that various other aspects and embodiments of the invention can be straightforwardly substituted.

1. A quick-release connector receptacle for use with a screw-type connector plug that carries external threads; said receptacle comprising:
a connector body for encircling such plug and such threads;
multiple individual, discrete pins mounted substantially radially in the body for engagement with such threads of such a plug so that the receptacle and such plug can be screwed together; and
means for withdrawing all the pins substantially simultaneously from such threads, to disengage the receptacle from such plug without unscrewing the receptacle from such plug.

2. The receptacle of claim 1, wherein:
each pin is generally cylindrical, but with one portion shaped for engaging the withdrawing means and another portion shaped for engaging such threads.

3. The receptacle of claim 1, wherein:
the withdrawing means comprise means for withdrawing the pins substantially radially.

4. The receptacle of claim 1, wherein:
the withdrawing means comprise at least one cam that drives the pins outward from such threads.

5. The receptacle of claim 4, wherein:
each pin has a respective feature that engages the at least one cam.

6. The receptacle of claim 5, wherein:
the feature is an enlargement; and
the at least one cam comprises at least one groove for receiving and driving the enlargement.

7. The receptacle of claim 1, wherein the withdrawing means comprise a control sleeve that is:
movable axially, relative to the body; and
defines at least one cam surface for driving the pine radially when the control sleeve moves axially.

8. The receptacle of claim 7, wherein:
the body comprises an inner sleeve and an outer sleeve, the inner sleeve being disposed radially outside the inner sleeve; and
the control sleeve is disposed radially between the inner and outer sleeves, and slides axially.

9. The receptacle of claim 7, wherein the withdrawing means further comprise:
manually operable means for moving the control sleeve axially to drive the pins radially.

10. The receptacle of claim 9, wherein:
the manually operable means comprise a lanyard for pulling the sleeve axially.

11. The receptacle of claim 1, in further combination with:
the plug.

12. The receptacle-and-plug combination of claim 11, wherein:
the plug is a D-38999 military plug.

13. The receptacle of claim 1, particularly for use with a said plug that has an array of electrical plug terminals; and further comprising:
an array of electrical connector terminals for mating with such electrical plug terminals.

14. The receptacle of claim 13, particularly for use with electrical wires; and wherein:
the electrical connector terminals are also adapted for terminating respective such electrical wires.

15. The receptacle of claim 1, wherein:
a radially innermost tip of each pin is shaped to match a cross-sectional profile of such threads.

16. The receptacle of claim 15, wherein:
the tip, and such cross-sectional profile, are complementarily tapered.

17. The receptacle of claim 1, wherein:
when engaged, the pins are distributed circumferentially about such plug.

18. The receptacle of claim 1, wherein:
the multiple pins comprise at least three pins.

19. The receptacle of claim 1, wherein:
the multiple pins comprise at least six pins.

20. The receptacle of claim 1, wherein:
the pins are spaced roughly equidistantly about a periphery of the body.

21. For use with a screw-type first half-connector that carries threads, a quick-release second half-connector comprising:
a connector body for generally concentric placement with such first half-connector and such threads;
multiple individual, discrete pins mounted substantially radially in the body for engagement with such threads of such first half-connector so that the receptacle and such plug can be screwed together; and
means for withdrawing all the pins substantially simultaneously from such threads, to disengage the second half-connector from such first half-connector without unscrewing the second half-connector from such first half-connector.

22. The second half-connector of claim 21, wherein:
each pin is generally cylindrical, but with one portion shaped for engaging the withdrawing means and another portion shaped for engaging such threads.

23. The second half-connector of claim 21, wherein:
the withdrawing means comprise means for withdrawing the pins substantially radially.

24. The second half-connector of claim 1, in further combination with:
the first half-connector.

25. A method for connecting and then disconnecting two electrical half-connectors; said method comprising the steps of:
fabricating or obtaining a first half-connector that is a screw-type half-connector;
fabricating or obtaining a second half-connector that comprises:
a body for generally concentric placement with such first half-connector and such threads, and
multiple individual, discrete pins mounted substantially radially in the body for engagement with such threads of such first half-connector so that the receptacle and such plug can be screwed together,
each of said pins being generally cylindrical but having one portion shaped for engaging such threads and another portion shaped to facilitate disengagement from such threads;
screwing the first and second half-connectors together; and
then using said other portion to disengage all the pins substantially simultaneously from such threads, to release the first and second half-connectors from each other without unscrewing them.

26. The method of claim 25, wherein:
the using step comprises operating at least one cam against said other portion.
